(19) United States
(12) Patent Application Publication
(10) Pub. No.: US 2012/0325052 A1
(43) Pub. Date: Dec. 27, 2012

(54) Method and Device for Producing a Radionuclide

(76) Inventors: Frank Rösch, Zornheim (DE); Dimitry Filosofov, Moskau (RU)

(21) Appl. No.: 13/500,328

(22) PCT Filed: Oct. 12, 2010
(86) PCT No.: PCT/EP2010/006209

§ 371 Date: Jun. 25, 2012

(30) Foreign Application Priority Data
Oct. 12, 2009 (DE) 10 2009 049 108.2

(51) Int. Cl. C22B 60/00; C22B 26/20; C22B 34/36; C22B 60/02; C22B 41/00; C22B 58/00; C22B 34/12; C22B 59/00; C22B 26/10; C22B 61/00

(52) U.S. Cl. 75/393; 266/168

(57) ABSTRACT

The present relates to a method and a device for producing a radionuclide in which an absorption column containing the radionuclide is eluted by means of an eluent in a first flow direction and subsequently in a second, opposite flow direction.

The present invention relates to a method for obtaining a radionuclide, in which an absorption column containing the radionuclide is eluted by an eluent, and to a device for carrying out the method.

Methods and devices for obtaining selected radionuclides for radiopharmacological applications have been disclosed in the prior art (DE 10 2004 057 225 B4). Herein, a radioactive mother nuclide is initially provided, which is stored in a container that is referred to as radionuclide generator. Use is usually made of a mother nuclide with a half-life of a few days to a few thousand years. By contrast, a likewise radioactive daughter nuclide—with a very long-lived or stable decay product—formed in the case of radioactive decay of the mother nuclide has a relatively short half-life of a few minutes or hours up to a few days. As a result of its short half-life, the daughter nuclide is suitable for radiopharmaceutical applications because the daughter nuclide introduced into the body of a patient merely emits radioactive radiation for a short period of time and hence the radiation dose is correspondingly low.

In order to minimize the radiation exposure during the application of a radioactive daughter nuclide, the long-lived mother nuclide must be separated from the daughter nuclide to the greatest possible extent.

The device according to the invention enables an effective radiochemical separation of the mother nuclide, and so a daughter nuclide is obtained with a high radionuclidic and radiochemical purity. Since the daughter nuclide generally decays into a very long-lived or stable end product, the above-described systems, in which the daughter nuclide has a shorter half-life than the mother nuclide, are ideally suited to medical applications. The medical applications of such daughter nuclides lie in the field of radiopharmaceutical chemistry, molecular imaging and/or nuclear-medical diagnostics and endoradiotherapy. Here, the rare combination of radioactive mother nuclides with short-lived daughter nuclides opens up significant chemical, logistic and economic advantages.

The above-described mother and daughter nuclides can be handled and are available in laboratory-technical surroundings. For the applications of the daughter nuclides as such, or for the synthesis of radioactively marked tracer compounds, it is not necessary to maintain a complicated “in-house production” like in the case of the short-lived positron emitters ¹¹C, ¹⁸F, etc., or to use expensive commercial initial products like in the case of typical SPECT nuclides, for example ¹²³I, ¹¹¹In or other important therapy nuclides.

As is well-known for the generator system ⁹⁹Mo/^{99m}Tc, a longer half-life of the mother nuclide and the simple handling of mother/daughter nuclide systems simplify the radiopharmaceutical synthesis and use for the medical patient care in a very decisive manner.

Even if it is very complicated in some cases to produce or obtain the mother nuclide by means of a particle accelerator or reactor, or from natural resources or decay chains, the economic and medical advantages of the mother/daughter nuclide systems by far outweigh these disadvantages. Various clinical applications can be implemented by means of a device for separating mother/daughter nuclide systems. As a result of the broad applicability, the costs arising per patient batch are reduced significantly.

A host of factors need to be taken into account for the practical use of mother/daughter nuclide systems in radiopharmacology and/or for the synthesis of radioactively marked tracer compounds for very different relevant medical questions. One of the core questions is the chemical and technical concept of the mother/daughter nuclide systems themselves. This relates to the development of an optimum separation strategy (in general ion exchange or solid-state extraction) with high yields of the daughter nuclide with minimal penetration of the mother nuclide; the selection of solvents suitable in a chemical and radiopharmaceutical sense; the avoidance of radiolysis effects; the separation duration; the final chemical form and the volume of the daughter nuclide fraction, etc.

Mother/daughter nuclide systems are established, in particular, in nuclear-medical diagnostics by means of SPECT, for example using the ⁹⁹Mo/^{99m}Tc system. In the case of endoradiotherapy, mother/daughter nuclide systems such as ⁹⁰Sr/⁹⁰Y and ¹⁸⁸W/¹⁸⁸Re have become indispensible. Moreover, in recent years, positron-emitting mother/daughter nuclide systems such as ⁸²Sr/⁸²Rb and ⁶⁸Ge/⁶⁸Ga are being increasingly used in clinical PET and PET/CT methods. In future, the mother/daughter nuclide system ⁴⁴Ti/⁴⁴Sc is also likely to obtain increased importance.

A mother/daughter nuclide system must satisfy various chemically and medically dependent demands and legal requirements. In particular, it is important to keep the therapeutic or diagnostic radiation exposure as low as possible by minimizing the content of the mother nuclide the so-called “breakthrough”—in the purified daughter nuclide. The allowed content of mother nuclide is regulated by pharmacological law and may not be exceeded during medical use.

The content of mother nuclide is substantially determined by the chemical concept of separation. The known chemical separation methods are based on liquid-liquid extraction or column chromatography. In the case of column chromatography, the daughter nuclide is partly or wholly deposited on a solid absorber and is washed out or eluted in a subsequent step by suitable, generally aqueous, eluents. Inorganic substances, such as oxides of the metals aluminum, silicon, tin, titanium, zirconium, etc., or organic anionic or cationic ion exchangers are preferably used as absorbers. Before the daughter nuclide is eluted, contaminants are optionally removed by means of secondary eluents, with the secondary eluents not reducing the content of the daughter nuclide in the absorber, or only reducing it to a small extent.

In the case of a given column material, the separation output is significantly influenced by the dimensions of the device, more particularly by the column volume and the column length. In general, the column volume and the column length should be designed to be that great that, firstly, the mother nuclide is completely absorbed and, secondly, the volume of eluent required for eluting the daughter nuclide is as low as possible.

In this case, it should be noted that there is a certain amount of co-elution of the mother nuclide as a result of chromatographic interactions between the absorber and the mother nuclide. Depending on column dimension, number of elutions or volume of the eluent, aging of the system, inter alia as a result of radiolytic processes, a zone of the absorber enriched with a mother nuclide expands or migrates in the direction of the eluent flow, as a result of which the breakthrough, i.e. the content of mother nuclide in the daughter nuclide eluate, increases.

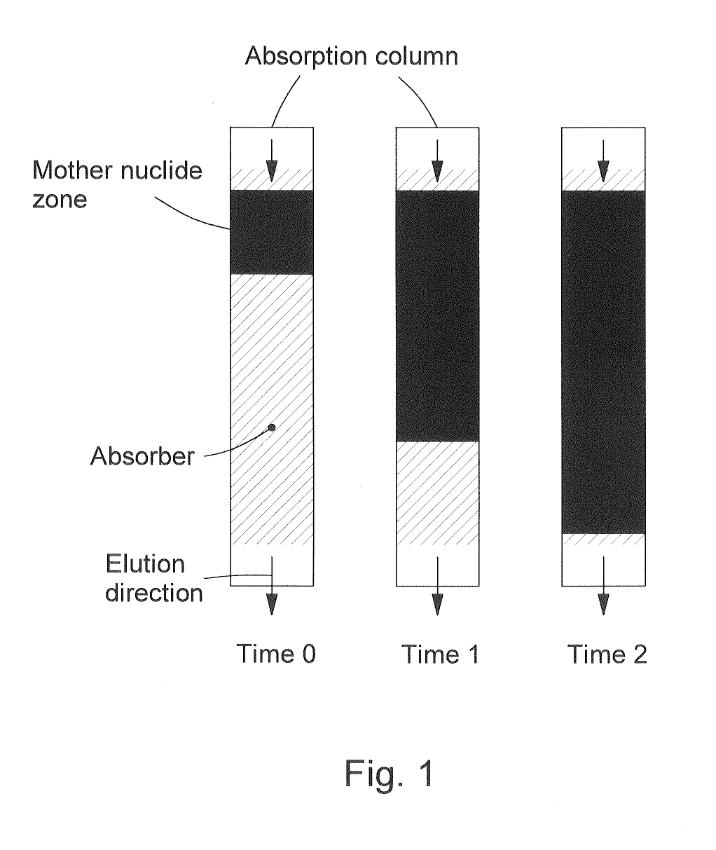

Breakthrough is particularly critical if it relates to long-lived mother nuclides. Thus, in the mother/daughter nuclide system ⁸²Sr/⁸²Rb, which has recently become relevant for medical applications, the mother nuclide ⁸²Sr has a half-life of more than 20 days (T_{1/2}=25.6 d). Further examples of systems with long-lived mother nuclides are: ¹⁸⁸W/¹⁸⁸Re with T_{1/2}(¹⁸⁸W)=694 d; ⁶⁸Ge/⁶⁸Ga with T_{1/2}(⁶⁸Ge)=271 d and ⁴⁴Ti/⁴⁴Sc with T_{1/2}(⁴⁴Ti)≈60 y. This elucidates the substantial difference to the mother/daughter nuclide system ⁹⁹Mo/⁹⁹Tc previously most commonly used in medicine: the half-life of the mother nuclide ⁹⁹Mo is only T_{1/2}=66 h. In this case, the increase in the breakthrough accompanying repeated elution and long periods of use is negligible. By contrast, in the aforementioned systems with significantly longer half-lifes of the mother nuclides, this is a serious problem (FIG. 1).

Accordingly, the object of the present invention is to provide a method in which the breakthrough of the mother nuclide absorbed on a column material is very low, even in the case of a high elution frequency, i.e. in the case of intensive use.

This object is achieved by a method for obtaining a radionuclide, comprising the following steps:
(a) providing an absorption column containing the radionuclide;
(b) eluting the absorption column with an eluent, the eluent flowing through the absorption column in a first flow direction; and
(c) eluting the absorption column with the eluent in a second flow direction, which is opposite to the first flow direction.

The method according to the invention more particularly comprises two embodiments, in which successive elutions are carried out with respectively opposite flow directions of the eluent (embodiment 1) or in which, after an initial elution, a subsequent “rinsing” of the absorption column is carried out in a flow direction that is opposite to the initial elution (embodiment 2).

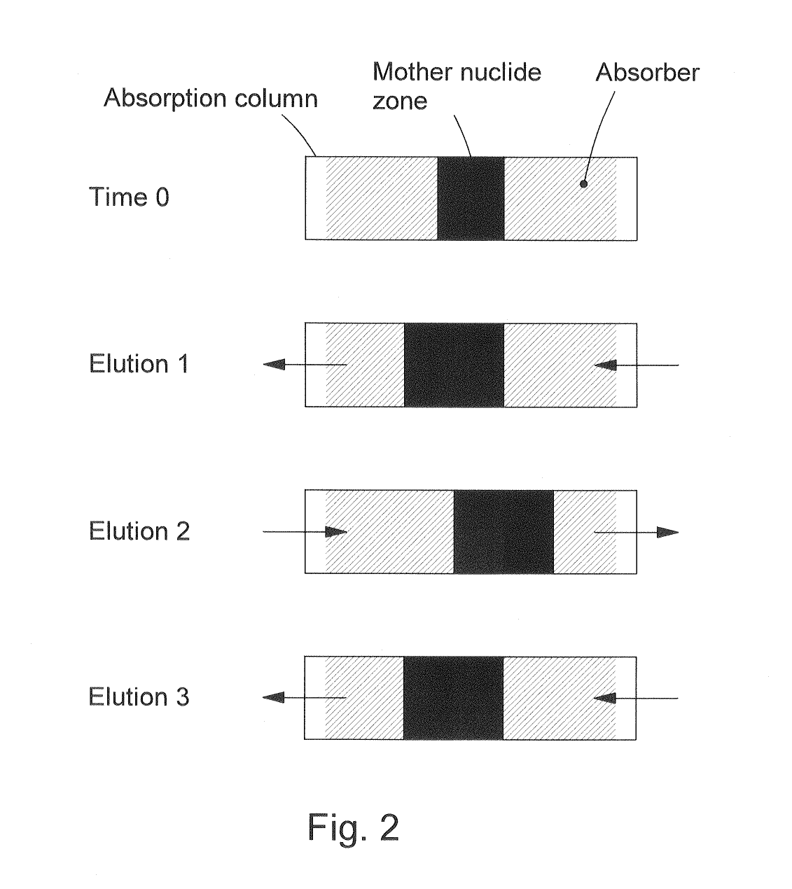

What this achieves in the case of the absorptions of the mother nuclide based on equilibria of the ion exchange (in the case of organic ion exchangers) is that the component of the mother nuclide migrating in the flow direction is pushed back again in the direction of its initial absorption zone (FIG. 2).

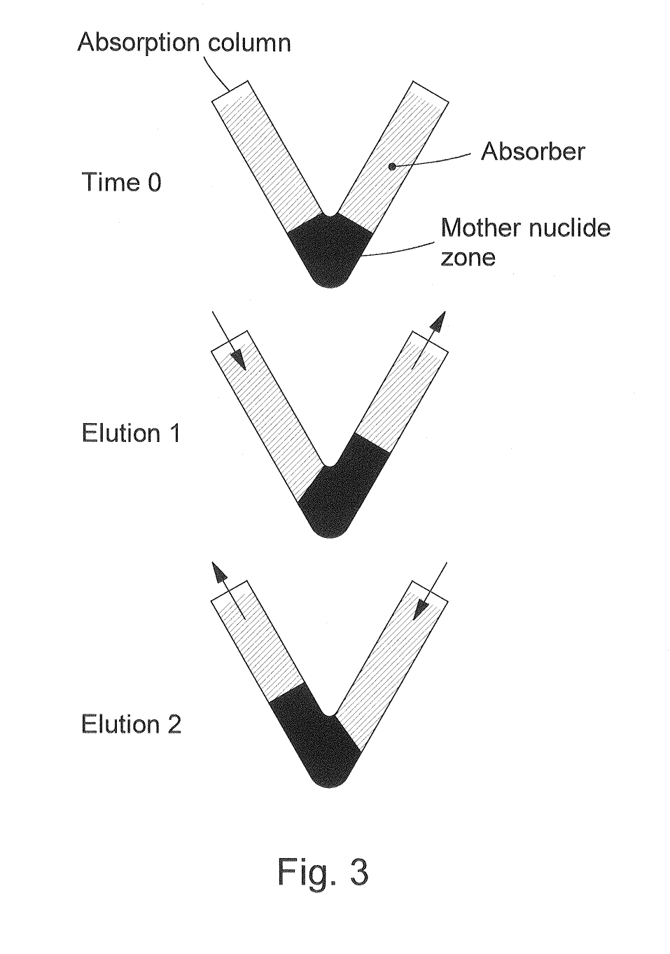

In the case of inorganic ion exchangers, the absorption of the mother nuclide is based on an equilibrium of the co-crystallization and is achieved by virtue of the fact that the component of the inorganic crystals of the column material containing the mother nuclide and migrating in the flow direction is pushed back again in the direction of the initial absorption zone (FIG. 3).

FIG. 1 illustrates the conventional (uni-directional) elution method according to the prior art. Here, the extent of the mother-nuclide-containing zone at the beginning of the use (time 0) and its gradual expansion (migration) in the direction of the daughter-nuclide elution (times 1 and 2) is shown. In the case of a short-lived mother nuclide, such as ⁹⁹Mo with T_{1/2}=66 h, the use has been completed at time 1 (complete decay of the mother nuclide), and so there is no breakthrough of the mother nuclide. However, in the case of long-lived mother nuclides with a half-life of more than a few days and relatively long usage, there is the breakthrough illustrated at time 2, with mother nuclide ending up in the eluate of the daughter nuclide in increased amounts.

FIG. 2 shows the elution principle according to the invention (“pendulum elution”) for a vertically arranged absorption column. Here, the extent of the mother-nuclide-containing zone is shown at the beginning of the usage (time 0) and the expansion and compression thereof (elutions 1, 2 and 3).

FIG. 3 illustrates a development of the method according to the invention with a V-shaped absorption column. Here, the extent of the mother-nuclide-containing zone is shown at the beginning of the usage (time 0) and the expansion and compression thereof (elutions 1 and 2).

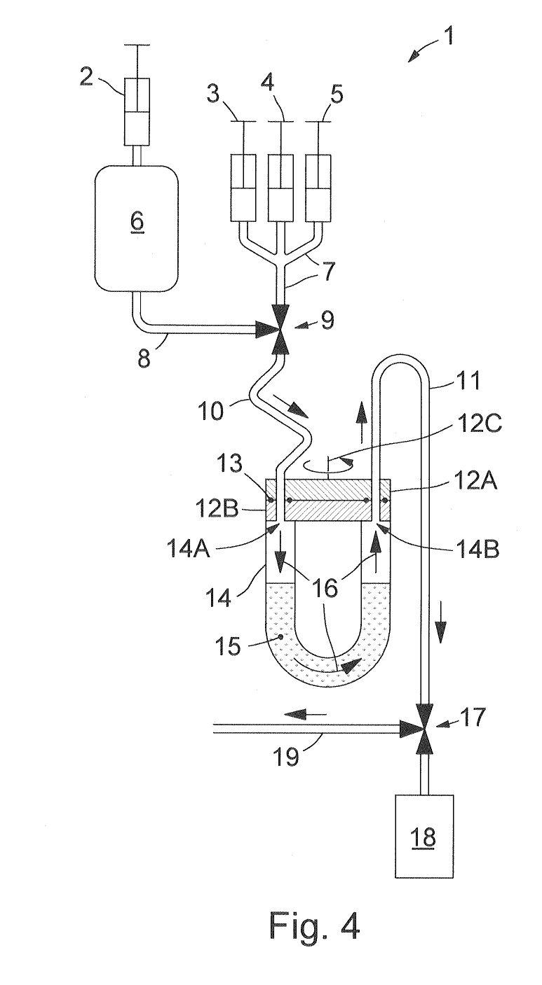

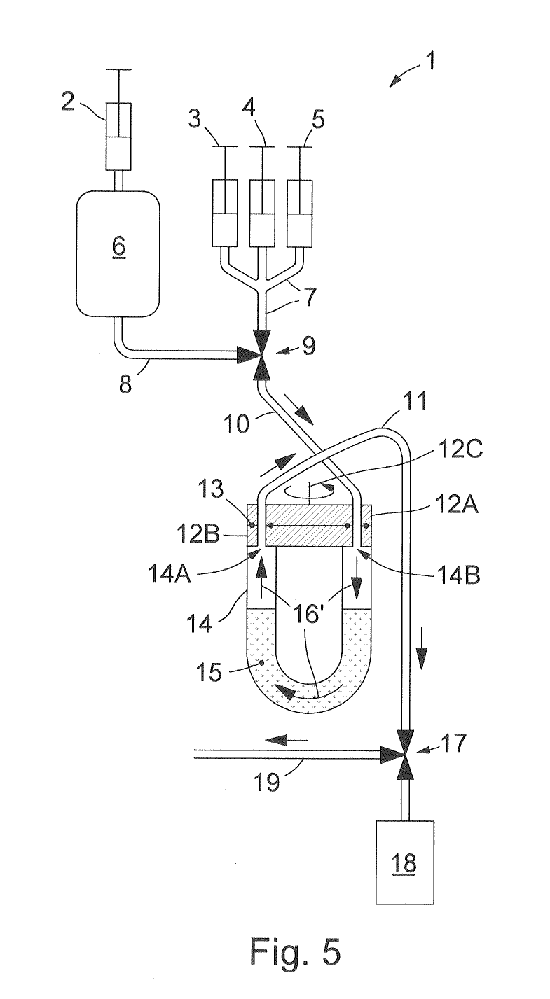

FIGS. 4 and 5 show, in an exemplary fashion, the mode of operation of a device 1 according to the invention for obtaining a radionuclide or daughter nuclide. Herein, a mother nuclide from a radionuclide generator or a storage container 6 is supplied to an absorption column 14 with an absorber 15. The mother nuclide is preferably transferred by liquid extraction using an initial eluent, which is supplied to the radionuclide generator or storage container 6 via a first pump 2. The mother nuclide reaches the absorption column 14 via lines 8, 10 and a multi-port valve 9 and, depending on quality and chemical composition of the absorber 15, is deposited in a small part (embodiment 2) or almost completely (embodiment 1). After a predetermined amount or a predetermined volume of initial eluent and mother nuclide contained therein was transferred into the absorption column 14 from the radionuclide generator or storage container 6, the daughter nuclide is eluted. The absorber 15 is optionally purified prior to the daughter-nuclide elution by, with the aid of pumps (3, 4, 5), pumping one or more secondary eluents through the absorption column 14 via lines 7 and the multi-port valve 9. The secondary eluents dissolve specific chemical contaminants out of the absorber, without in the process reducing the content of daughter nuclide in the absorber 15 in a significant manner. One of the pumps (3, 4, 5) is preferably provided for conveying the eluent for the daughter nuclide. In the case of short-lived mother nuclides, the eluent for the daughter nuclide can optionally also be supplied by means of the pump 2, with the absorber 15 needing to have high retention capabilities for the mother nuclide.

The absorption column 14 has a first and second opening (14A, 14B), through which the various eluents are supplied or discharged. Furthermore, the absorption column 14 is connected to an adjustable fluid coupling (12A, 12B), which makes it possible to reverse the flow direction (16, 16′) of the eluents through the absorber column 14. In the position of the fluid coupling (12A, 12B) shown in FIG. 4, the eluent flows from the first opening 14A to the second opening 14B, as indicated by the directional arrows 16. In the configuration illustrated in FIG. 5, the eluent flows in the opposite direction, indicated by the arrows 16′, from the second opening 14B to the first opening 14A.

By way of example, the reversal of the flow direction (16, 16′) is implemented by virtue of the fluid coupling comprising a first and second channel plate (12A, 12B), with at least one of the channel plates 12A or 12B being rotatably mounted about an axis 12C and each of the channel plates having two ducts. The ducts of the channel plates (12A, 12B) are arranged such that, by rotation about the axis 12C, each of the two ducts of the channel plate 12A can simultaneously be made to coincide with each of the two ducts of the channel plate 12B such that two channels are available for passing a fluid through the fluid coupling (12A, 12B).

The two openings of the first channel plate 12A are connected to lines 10 and 11, with the line 10 connecting the absorption column 14 to the radionuclide generator or storage container 6 (optionally via the multi-port valve 9). The line 11 is used to transfer an eluent passed through the absorption column 14 into a collection vessel 18 or, via the multi-port valve 17 and the line 19, to a removal or synthesis station for the eluate enriched with the daughter nuclide.

According to the illustration in FIGS. 4 and 5, the first or upper channel plate 12A is rotatably mounted. Accordingly, the lines 10 and 11 connected to the channel plate 12A are embodied as flexible tubes such that they can follow a rotation of the channel plate 12A. In an alternative development of the device according to the invention (not shown in FIGS. 4 and 5), the second channel plate 12B and the absorption column 14 fixedly connected thereto are mounted in a rotatable manner, while the first channel plate 12A, connected to the lines 10 and 11, is fixed.

In another expedient embodiment of the device according to the invention, provision is made for a commercially available multi-port valve with two direct and two crossed channels for reversing the flow direction (16, 16′) of the eluent in the absorption column 14. The use of such a multi-port valve renders it possible to configure a device such that neither the lines 10 and 11 nor the absorption column 14 are moveable.

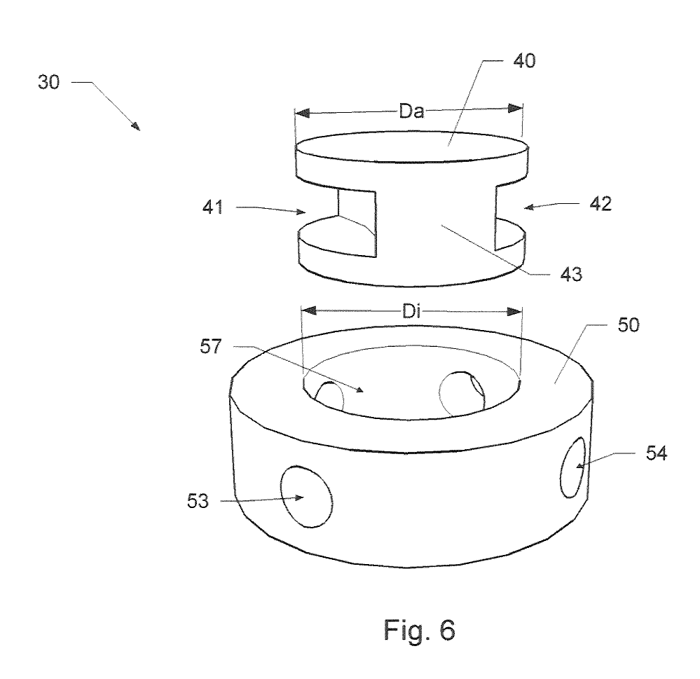

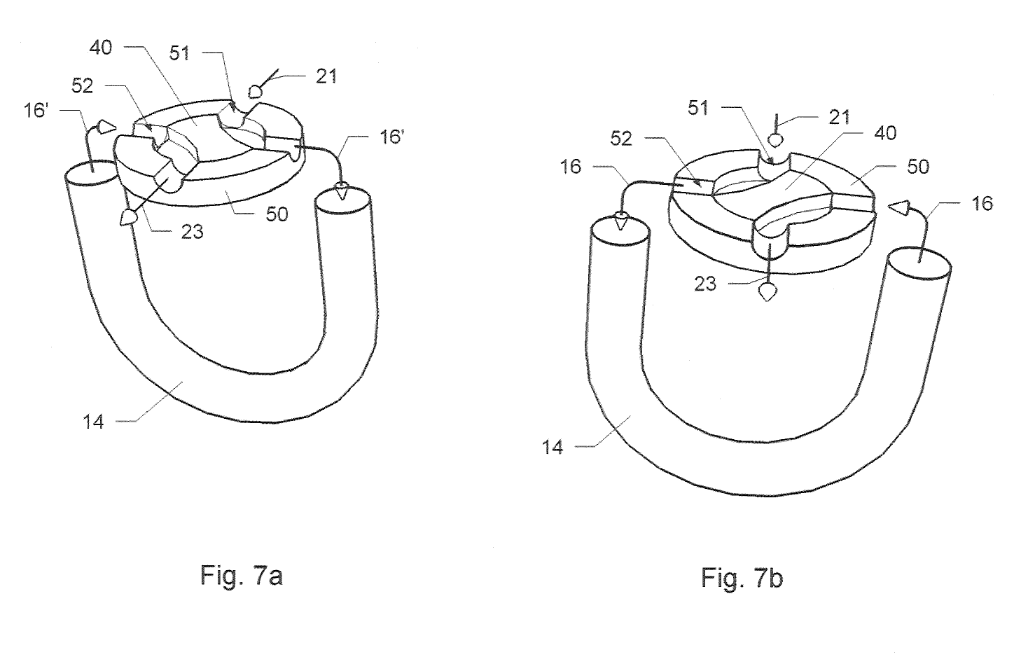

A further cross valve 30 according to the invention is shown in FIGS. 6, 7a and 7b. According to the exploded view in FIG. 6, the cross valve 30 comprises an inner and an outer valve body 40 and 50, respectively. The inner valve body 40 is substantially embodied like a cylinder, cone or frustum. The reference sign Da refers to the external diameter of the valve body 40. The lateral surface of the valve body 40 with a shape like a cylinder, cone or frustum has two recesses or channels 41 and 42, which are separated from one another in a fluid-tight manner by a web 43. The channels 41 and 42 run substantially parallel to one another.

In the operating state, the valve body 40 is rotatably arranged in a cylindrical or conical bore 57 of the outer valve body 50. In the cylindrical embodiment of the cross valve 30, the bore 57 or the valve body 50 has an internal diameter Di, which is only insignificantly greater than the external diameter Da of the inner valve body 40. The difference between Di and Da, i.e. (Di-Da), is typically 0.5 to 10 μm, preferably 0.5 to 4 μm. Accordingly, the fit between the inner and outer valve body 40 and 50 is fluid-tight.

The outer valve body 50 has four ducts (51, 52, 53, 54) for supplying and discharging an eluate. The four ducts (51, 52, 53, 54) are labeled in a conventional mathematical sense, i.e. increasing in the case of circumnavigating the outer valve body 50 in an anticlockwise direction. The ducts (51, 52, 53, 54) are preferably embodied as cylindrical bores, the longitudinal axes of which are aligned perpendicular and radial with respect to the axis of symmetry of the bore 57. Here, the term “radial” denotes an arrangement in which the longitudinal axes of the ducts (51, 52, 53, 54) lie in a coplanar manner in a plane arranged with respect to the axis of symmetry of the bore 57 and intersect at the point where the axis of symmetry of the bore 57 passes through this plane. Here, the longitudinal axes of the ducts (51, 52, 53, 54) are preferably aligned like a cross, i.e. along two main axes rotated by 180 degrees with respect to one another. The above-described “cross-like” or “radial” arrangement of the ducts (51, 52, 53, 54) is expedient and advantageous from a manufacturing point of view. Nevertheless, arrangements deviating from this are also provided according to the invention, in which the longitudinal axes of the ducts (51, 52, 53, 54) are rotated by an angle between 0 and 90 degrees with respect to the radial direction, like the blades in a turbine. The essential features (i) and (ii) according to the invention for the function of the cross valve 30 are briefly listed below:
(i) The ducts (51, 52, 53, 54) and the openings thereof on the inner and outer side of the valve body 50 are separated from another in a fluid-tight manner or arranged at a spatial distance from one another; and
(ii) Respectively two mutually adjacent ducts (51, 54) or (51, 52) and (52, 53) and (53, 54) of the outer valve body 50 can simultaneously be connected to one another via the channels 41 or 42 of the inner valve body 40, with the connection 51 to 54 or 51 to 52 respectively being separated in a fluid-tight manner by the web 43 from the connection 52 to 53 or 53 to 54.

The above feature (ii) is represented in an illustrative manner in FIGS. 7a and 7b, and also in table 1 below.

FIGS. 7a and 7b show two perspective sectional views of a cross valve 30, cut open along a transversal central plane, with the inner valve body 40 being arranged in two positions respectively rotated by 90 degrees with respect to one another. In the arrangement shown in FIG. 7a, the ducts 51 and 54 are interconnected, as are 52 and 53. By contrast, FIG. 7b shows a position in which ducts 51 and 52, and also 53 and 54, are interconnected.

| | 1st duct | | Channel | | 2nd duct |
|---|---|---|---|---|---|
| FIG. 7a | 51 | → | 42 | → | 54 |
| | 52 | → | 41 | → | 53 |
| FIG. 7b | 51 | → | 41 | → | 52 |
| | 53 | → | 42 | → | 54 |

The reference signs 14, 16 and 16′ in FIGS. 7a and 7b have the same meaning as in FIGS. 4 and 5. Accordingly, the absorption column is denoted by numeral 14, while the directional arrows 16 and 16′ specify the flow direction of the eluate through the absorption column 14. The directional arrows denoted by the numerals 21 and 23 specify the inlet flow and discharge of the eluate through the lines 10 and/or 11 (see FIGS. 4 and 5), which are connected to the ducts 51 and 53. In order to keep FIGS. 7a and 7b clearly laid-out, the lines 10 and 11 have not been illustrated. In an analogous fashion, the two openings of the absorption column 14 are connected to the ducts 52 and 54 by lines (likewise not shown in FIGS. 7a and 7b).

FIGS. 7a and 7b make it clear that the flow direction of the eluate in the inlet flow 21 and in the discharge 23 (i.e. in lines 10 and 11) is constant, independently of the position of the inner valve body 40. By contrast, if the inner valve body is rotated by 90 degrees, the flow direction of the eluate through the absorption column 14 is reversed from 16′ to 16. Hence the cross valve 30 satisfies the same function as the fluid coupling 12A/12B in FIGS. 4 and 5.

The inner and outer valve body 40 and 50 are expediently manufactured from a metallic or polymer material, such as stainless steel or Teflon.

As mentioned above, embodiments are moreover provided according to the invention in which the inner valve body 40 and the bore 57 have a conical contour or the shape of a frustum.

The inner valve body is expediently coupled to an electrically driven actuator (not illustrated in FIGS. 7a and 7b), more particularly a stepper motor, by means of a shaft. Advantageously, the stepper motor and other components of the device according to the invention, such as the conveying apparatuses or pumps 2 to 5 (see FIGS. 4 and 5), are controlled in a fully automatic manner by an electronic controller, more particularly a programmable logic controller (PLC). Here, according to a control program stored in the PLC, the inner valve body 40 can be rotated at regular intervals between the above-described positions, which are offset with respect to one another by 90 degrees, and the flow direction of the eluate between 16′ and 16 can be reversed.

### EXAMPLE FOR EMBODIMENT 1

According to the prior art, the mother nuclide ⁶⁸Ge as a tetravalent cation is placed on an absorber made of modified TiO₂ such that the ⁶⁸Ge remains in the upper quarter of the column (cf. FIG. 1 at time 0). The elution of ⁶⁸Ga is brought about using 0.1 N HCl (=0.1 mol/l HCl). The elution volume lies between 3 and 10 ml for an elution of the ⁶⁸Ga that is as quantitative as possible. Further elutions can be undertaken in quick succession because the daughter nuclide ⁶⁸Ga is generated rapidly. After 1, 2, 3 or 4 half-lifes of the daughter nuclide ⁶⁸Ga, i.e. after approximately 68 minutes, 2.3 hours, 3.4 hours or 4.5 hours, approximately 50%, 75%, 87.5% or 93.7% of the total available ⁶⁸Ga activity has been converted. The content of ⁶⁸Ge in the daughter-nuclide elutions that follow the initial elution undertaken with 0.1 N HCl respectively is approximately 1·10⁻³%. After 100 elutions, the content of ⁶⁸Ge generally increases and reaches values of approximately 1·10⁻²%.

By contrast, according to the present invention, a volume of 3 to 10 ml 0.1 N HCl is passed through the absorption column directly after a daughter nuclide or ⁶⁸Ga elution, in a flow direction opposing the initial elution and the ⁶⁸Ga elution. The volume thus passed through the absorption column contains hardly any ⁶⁸Ga activity and is discarded. Accordingly, this process is also referred to as “rinsing”. After rinsing, the absorption column is available for the next ⁶⁸Ga elution. However, as a result of rinsing, the zone of the ⁶⁸Ge distribution has again been shifted back in the direction of the initial absorbtion zone. As a result, the ⁶⁸Ge content in the subsequent ⁶⁸Ga elution is substantially reduced. In the case of 100 elutions according to the aforementioned method according to the invention, the breakthrough of ⁶⁸Ge is only at approximately 2·10⁻³% instead of the approximately 1·10⁻²% expected otherwise.

### EXAMPLE FOR EMBODIMENT 2

According to the prior art, the mother nuclide ⁶⁸Ge as a tetravalent cation is placed on an absorber made of modified TiO₂ such that the ⁶⁸Ge remains in the middle of the column (cf. FIG. 1) at time 0. The elution of ⁶⁸Ga is brought about using 0.1 N HCl. The elution volume lies between 3 and ml for an elution of the ⁶⁸Ga that is as quantitative as possible. Further elutions can be undertaken in quick succession because the daughter nuclide ⁶⁸Ga is generated rapidly. After 1, 2, 3 or 4 half-lifes of the daughter nuclide ⁶⁸Ga, i.e. after approximately 68 minutes, 2.3 hours, 3.4 hours or 4.5 hours, approximately 50%, 75%, 87.5% or 93.7% of the total available ⁶⁸Ga activity is present. The content of ⁶⁸Ge in the elutions that the initial elutions of the undertaken with 0.1 N HCl, respectively lies at approximately 2·10⁻³%. After 100 elutions, this content generally increases and reaches values of approximately 1·10⁻²%.

By contrast, according to the present invention, subsequent daughter nuclide or ⁶⁸Ga elutions are respectively undertaken in opposing flow directions (cf. FIG. 3). Here, each of the daughter-nuclide elutions contains a ⁶⁸Ga activity that is adequate for medical use. The absorption column is available for subsequent daughter-nuclide elutions without interposition of rinsing steps. The ⁶⁸Ge-containing zone is shifted or compressed in the direction of its initial absorbtion zone as a result of the elutions with alternately opposing flow directions. As a result, the ⁶⁸Ge content of successive ⁶⁸Ga elutions is significantly reduced. In the case of 100 elutions according to the method according to the invention, the breakthrough of ⁶⁸Ge is only at approximately 2·10⁻³% instead of the otherwise expected approximately 1·10⁻²%.

In addition to regulating chromatographic processes, the vertical alignment shown in FIG. 3 is connected to an additional effect, which is exhibited in operating pauses (“stand-by phases”) between two successive elutions. Stand-by phases occur in the case of daily use with usual clock cycles of, for example, 1 to 4.5 hours, and also overnight or at the weekend between the last and the first elution on two successive work days. What the vertical alignment of the system according to FIG. 3 brings about is that TiO₂ particles, co-eluted over a stand-by phase, with a content of absorbed ⁶⁸Ga mother nuclide sink and collect or enrich at the base of the absorption column. Connected to the “entrapment” of the ⁶⁸Ge mother nuclide in a localized spatial zone there is a reduction in the breakthrough during the next daughter-nuclide elution.

### LIST OF REFERENCE SIGNS

1 Device for obtaining a radionuclide
2-5 Pump (deliver piston, rotary vane or peristaltic pump)
6 Radionuclide generator or storage container with mother nuclide
7, 8 Lines
9 Multi-port valve
10, 11 Lines (more particularly flexible tubes)
12A/12B Fluid coupling (first and second channel plate)
13 Seal
14 Absorption column
14A/14B First and second opening
15 Absorber
16/16′ Directional arrows, flow or elution direction
17 First multi-port valve
18 Collection container
19 Line (to the product or synthesis vessel)
21 Directional arrow, eluate inlet flow
23 Directional arrow, eluate discharge
30 Second multi-port valve
40 Inner valve body
Da External diameter, inner valve body
41/42 Recesses or channels
50 Outer valve body
51-54 Ducts
57 Bore
Di Internal diameter of the bore 57

1. A method for obtaining a radionuclide, comprising the following steps:
(a) providing an absorption column containing the radionuclide;
(b) eluting the absorption column with an eluent, the eluent flowing through the absorption column in a first flow direction; and
(c) eluting the absorption column with the eluent in a second flow direction, which is opposite to the first flow direction.

2. The method as claimed in claim 1, wherein steps (b) and (c) are repeated once or more than once.

3. The method as claimed in claim 1, wherein, in step (a), a radionuclide generator is eluted with an initial eluent and an initial eluate obtained thereby is passed through the absorption column.

4. The method as claimed in claim 1, wherein step (a) further comprises eluting the absorption column once or more than once with one or more secondary eluents to remove contaminants.

5. The method as claimed in claim 1, wherein the absorption column provided in step (a) contains an isotope mixture of a radioactive mother nuclide and radioactive daughter nuclides, said isotope mixture selected from the group comprising 82Sr/82Rb with a half-life T_{1/2}(82Sr)=25.6 d; 188W/188Re with T_{1/2}(188W)=69.4 d; 68Ge/68Ga with T_{1/2}(68Ge)=271 d; 44Ti/44Sc with T_{1/2}(44Ti)≈60 y; 225Ac/213Bi with T_{1/2}(225Ac)=10.6 d; 90Sr/90Y with T_{1/2}(90Sr)=28.5 y; 229Th/(225Ra)225Ac with T_{1/2}(229Th)=7340 y; and 227Ac/(223Th)223Ra with T_{1/2}(227Ac)=21.77 y.

6. The method as claimed in claim 1, wherein the absorption column contains an absorber made of an inorganic substance or an organic substance.

7. The method as claimed in claim 1, wherein the eluent in steps (b) and (c) is selected from the group comprising aqueous acids, aqueous alkalis and aqueous salt solutions, said eluent optionally containing complex-forming ligands.

8. A device for obtaining a radionuclide according to a method as claimed in claim 1 comprising an absorption column with first and second openings and first and second lines, connected to the absorption column via an adjustable fluid coupling or a cross valve, for supplying and discharging an eluent, wherein, in a first position of the fluid coupling or the cross valve, the first line is connected to the first opening and the second line is connected to the second opening and, in a second position of the fluid coupling or the cross valve, the first line is connected to the second opening and the second line is connected to the first opening.

9. The device as claimed in claim 8, wherein the absorption column comprises a tubular container with two limbs arranged in a U- or V-shaped manner.

10. The device as claimed in claim 8, wherein the absorption column comprises an absorber made of an inorganic substance or an organic substance.

11. The device as claimed in claim 8, wherein the fluid coupling comprises a first and second channel plate, each of the channel plates has two ducts, at least one of the channel plates is rotatably mounted and one of the channel plates is coupled to the absorption column in a fluid-tight manner with one of the ducts of the channel plate connected to the first opening and the other duct connected to the second opening of the absorption column.

12. The device as claimed in claim 8, wherein the lines are tubes and manufactured from an elastic material.

13. The device as claimed in claim 8, said device further comprising a radionuclide generator, optionally one or more pumps and optionally one or more multi-port valves, the absorption column being connected to the radionuclide generator via one of the lines.

14. The device as claimed in claim 13, wherein the radionuclide generator contains an isotope mixture of a radioactive mother nuclide and radioactive daughter nuclides, said isotope mixture selected from the group comprising 82Sr/82Rb with a half-life T_{1/2}(82Sr)=25.6 d; 188W/188Re with T_{1/2}(188W)=69.4 d; 68Ge/68Ga with T_{1/2}(68Ge)=271 d; 44Ti/44Sc with T_{1/2}(44Ti)≈60 y; 225Ac/213Bi with T_{1/2}(225Ac)=10.6 d; 90Sr/90Y with T_{1/2}(90Sr)=28.5 y; 229Th/(225Ra)225Ac with T_{1/2}(229Th)=7340 y; and 227Ac/(223Th)223Ra with T_{1/2}(227Ac)=21.77 y.

15. The method as claimed in claim 6, wherein the inorganic substance is an oxide of the metals aluminum, silicon, tin, titanium or zirconium and the organic substance is an anionic or cationic ion exchanger.

16. The device as claimed in claim 10, wherein the inorganic substance is an oxide of the metals aluminum, silicon, tin, titanium, or zirconium, and the organic substance is an anionic or cationic ion exchanger.

17. The device as claimed in claim 12, wherein the elastic material is a polymer material.
